(19) United States
(12) Patent Application Publication
(10) Pub. No.: US 2015/0301955 A1
(43) Pub. Date: Oct. 22, 2015

(54) EXTENDING PROTECTION DOMAINS TO CO-PROCESSORS

(71) Applicant: QUALCOMM Incorporated, San Diego, CA (US)

(72) Inventors: Anatoly E. YAKOVENKO, Encinitas, CA (US); Sathish Subramaniam AMBLEY, San Diego, CA (US); Ramesh CHANDRASEKHAR, Oceanside, CA (US)

(73) Assignee: QUALCOMM Incorporated, San Diego, CA (US)

(21) Appl. No.: 14/257,997

(22) Filed: Apr. 21, 2014

(51) Int. Cl. G06F 12/14

(52) U.S. Cl. CPC G06F 12/14; G06F 2212/1052

(57) ABSTRACT

Systems and methods relate to safely and efficiently operating a multiprocessing system involving cooperation of a first processor and a second processor. For example, with regard to a first process of a first processor to be handed off to a second processor for execution, a first memory protection domain (PD) is created in a common memory, the first memory PD corresponding to the first process. The first memory PD is extended between the first processor and the second processor such that the second processor is enabled to execute the first process within the first memory PD. With regard to the first process, accesses to the common memory by the first and second processors are limited to the first memory PD, which ensures safety of the first and second processors from one another.

### FIELD OF DISCLOSURE

Disclosed aspects are directed to efficient and secure cooperation between processing elements of a multiprocessor system. More specifically, some exemplary aspects are directed to creation of a protection domain in a common memory accessible by a main processor and a coprocessor, and cooperation between the main processor and the coprocessor by means of the protection domain.

### BACKGROUND

Multiprocessor or multi-core processor systems are well-known in modern processing and computing applications. They may involve cooperation of two or more processors or processor cores, such as a main processor configured for general purpose computing and one or more coprocessors configured for specialized tasks. Examples of coprocessors include vector processors, digital signal processors (DSPs), audio DSPs, modem DSPs, floating point processors, graphics processing units (GPUs), etc. The main processor and the one or more coprocessors may be heterogeneous in that they may involve different architectures, different operating systems, etc. The main processor and the one or more coprocessors may also share or have access to one or more common memory structures.

The multiple processors of a multiprocessor system may be packaged in a single package or a system on a chip (SoC). With advances in network systems and high speed connectivity of processing entities in remote locations through the Internet, for example, it is possible to configure multiprocessor systems from two or more processor cores without restrictions on where the two or more processor cores are located. It is also possible to form ad-hoc connections between two or more processor cores to cooperate in a multiprocessing environment for specialized tasks or limited durations. Such multiprocessing configurations may be formed or initiated by a main processor wishing to offload a specific computational task or function to a coprocessor, for example, by means of a remote procedure call (RPC). RPCs may be made to coprocessors located anywhere, without restriction to the same package or SoC as the main processor. In some cases, a remote processor may also request a connection to the main processor in order to execute one or more processes on the main processor's operating system.

While the above multiprocessing configurations offer desirable flexibility, efficient management, and distribution of computational resources, they are also vulnerable to security concerns and malicious attacks. For example, if a main processor opened up its operating system for the sake of cooperation with a coprocessor, then malicious code from the coprocessor can affect the main processor, and may lead to serious and permanent damage in some cases. The reverse scenario is also possible where the coprocessor' s security may also be at risk or threatened by malicious code originating from the main processor. For example, malicious code may be inadvertently loaded into the main processor's operating system. This malicious code may be transferred to the coprocessor when offloading the process from the main processor, thus resulting in the coprocessor also getting exposed to corruption or crashing.

Conventional approaches to resolving security concerns in such multiprocessing environments have focused on building client/server components between the main processor and the coprocessor for example. These client/server components are configured to overlay and monitor communications between the main processor and coprocessor and may implement, for example, translation mechanisms, encryption/decryption mechanisms, verification processes, etc. These conventional approaches may need to be highly customized and tailored, for example, for each RPC made by a main processor. As such, these conventional approaches may be highly time consuming and expensive to implement. These conventional approaches may also lead to degradation of speed and computational efficiency.

Accordingly, there is a need in the art for efficient and secure integration and cooperation of multiple processors in a multiprocessing environment which avoids the aforementioned problems associated with the conventional approaches.

### SUMMARY

Exemplary aspects of this disclosure are directed to systems and methods for safely and efficiently operating a multiprocessing system involving cooperation of a first processor and a second processor. For example, with regard to a first process of a first processor to be handed off to a second processor for execution, a first memory protection domain is created in a common memory, the first memory protection domain corresponding to the first process. The first memory protection domain is extended between the first processor and the second processor such that the second processor is enabled to execute the first process within the first memory protection domain. With regard to the first process, accesses to the common memory by the first and second processors are limited to the first memory protection domain, which ensures safety of the first and second processors from one another.

For example, an exemplary embodiment is directed to a method of operating a multiprocessing system, the method comprising: determining a first process of a first processor to be handed off to a second processor for execution, creating a first memory protection domain in a common memory, the first memory protection domain corresponding to the first process, and extending the memory protection domain between the first processor and the second processor such that the second processor is enabled to execute the first process within the first memory protection domain.

Another exemplary embodiment is directed to multiprocessing system comprising: a common memory, a first processor configured to handoff a first process to a second processor for execution, and a first memory protection domain in the common memory, the first memory protection domain corresponding to the first process and configured to be extended between the first processor and the second processor such that the second processor is enabled to execute the first process within the first memory protection domain.

Yet another exemplary embodiment is directed to a multiprocessing system comprising: a common means for storing, and a first means for processing configured to handoff a first process for execution to a second means for processing. The common means for storing comprises a first memory protection domain, the first memory protection domain corresponding to the first process and configured to be extended between the first means for processing and the second means for processing such that the second means for processing is enabled to execute the first process within the first memory protection domain.

Another exemplary embodiment is directed to a non-transitory computer-readable storage medium comprising code, which, when executed by a processor, causes the processor to perform operations for operating a multiprocessing system, the non-transitory computer-readable storage medium comprising: code for determining a first process of a first processor to be handed off to a second processor for execution, code for creating a first memory protection domain in a common memory, the first memory protection domain corresponding to the first process, and code for extending the memory protection domain between the first processor and the second processor such that the second processor is enabled to execute the first process within the first memory protection domain.

### BRIEF DESCRIPTION OF THE DRAWINGS

The accompanying drawings are presented to aid in the description of aspects of the invention and are provided solely for illustration of the aspects and not limitation thereof.

FIGS. 1 and 2 depict schematic views of an exemplary multiprocessor system 100 configured according to exemplary aspects.

FIG. 3 is a flow chart related to an exemplary method for operating a multiprocessing system according to exemplary aspects of this disclosure.

FIG. 4 illustrates an exemplary wireless device 400 in which an aspect of the disclosure may be advantageously employed.

### DETAILED DESCRIPTION

Aspects of the invention are disclosed in the following description and related drawings directed to specific aspects of the invention. Alternative aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Aspects of this disclosure are directed to fast, secure, and efficient integration and cooperation between processing elements, such as a first processor/first means for processing and a second processor/second means for processing of a multiprocessing system or environment. In some aspects, the first and second processors may be heterogeneous, in that they may have different operating systems and/or different instruction set architectures (ISAs). In an exemplary aspect, the first processor may be coupled to a memory element, such as a shared or shareable common memory/common means for storing. The first processor may be a main processor operated by a first operating system, such as a high level operating system (HLOS). The common memory may be a main memory (e.g., a random access memory (RAM)). The first processor may be configured to handoff a first process to the second processor, for example, using a remote procedure call (RPC). The second processor may be a coprocessor such as an audio DSP (aDSP), and the second processor may be operating under a second operating system.

The handoff of the first process from the first processor to the second processor may be safely and efficiently accomplished by creation of a first memory protection domain (PD) in the common memory. The first memory PD may comprise a first portion of physical memory space in the common memory. The first memory PD may be extended to the coprocessor. The coprocessor may be granted access and permissions to the first memory PD, for example, of equal scope as the access and permissions of the first processor with regard to the first memory PD, such that the coprocessor can be enabled to execute the first process within the first memory PD. With regard to the first process, the first processor as well as the second processor may be limited to the first memory PD, in that the first memory PD is configured to function as a safe zone. The remainder of the physical memory space of the common memory, which is not occupied by the first memory PD, may be immune from any malfunctions that may occur within the first memory PD. By limiting access to the first and second processors to the first memory PD in this manner, the first and second processors may be protected from each other. The second processor may execute the first process directly by accessing the physical memory space within the first memory PD of the common memory. Copying or transferring memory space to the second processor for execution of the first process can be avoided.

As previously mentioned, the first and second processors may be heterogeneous.

Accordingly, the first and second operating systems corresponding to the first and second processors, respectively, may be different. Additionally or alternatively, the first and second processors may also involve corresponding different first and second instruction set architectures (ISAs), for example. As such, virtual memory spaces of the first and second processors may translate differently to physical memory spaces in the common memory. Accordingly, creating and extending the first memory PD between the first and second processors can involve mechanisms to account for the different virtual-to-physical memory translations that are native to the first and second processors.

For example, when the first process is encountered within the context of the first processor, the first processor may initiate a RPC to the second processor for handing off the first process to the second processor, whereby a first memory PD may be created in the common memory. In further detail, initiating the RPC may involve the first processor making a request or a system call to a first kernel. The first kernel may manage resources on the common memory. As such, when the first kernel receives the request, the first kernel may translate first virtual address space related to the first processor operating under the first operating system (e.g., HLOS) and map or convert the first virtual address into physical memory space in the common memory. For example, the pages in the common memory which relate to the first process may be mapped. This physical memory space related to the first process may be sandboxed into a first memory protection domain (PD). The first kernel may limit all accesses related to the first process to the physical memory space contained within the first memory PD. This means that the first processor, as well as the second processor, will be limited to the first memory PD when it comes to executing the first process. Therefore, any corruption which may arise due to execution of the first process will be contained within the first memory PD, thereby protecting the remainder of the common memory from possible corruption.

When the first memory PD has been created as above, the first kernel may then forward the request to a second kernel related to the second processor to which the RPC is directed. The request can be forwarded over a streaming channel, by means of a local bus or a system bus, for example. While forwarding the request, the first kernel may inform the second kernel of the physical memory space related to the first process, and contained in the first memory PD in the common memory. The second kernel may then map or convert the physical memory space into a second virtual address related to the second processor operating under the second operating system. In this manner, the first memory PD can be extended to the second processor. The second processor can execute the first process directly by accessing the common memory, where such access is limited to the first memory PD.

Accordingly, creating and extending the first memory PD can involve: initiating a RPC by the first processor to handoff the first process to the second processor, translation of the first virtual memory space of the first processor to physical memory space in the common memory, creation of the first memory PD in the corresponding physical memory space, forwarding information related to the first memory PD to the second processor, and translation of the physical memory space in the first memory PD to second virtual memory space related to the second processor. Extending the first memory PD to the second processor may also involve additional verification or security checks. Once the first memory PD is extended to the second processor, the first process can be handed off to the second processor, whereby the second processor is enabled to execute the first process with unrestricted access to the first memory PD. The second processor may update results of execution of the first process directly in the common memory, within the first memory PD. The first processor can also access the results of the execution of the first process directly from the common memory, in the first memory PD. Thus, high speed and efficiency of cooperation of the first and second processors can be achieved.

On similar lines as above, one or more additional memory PDs may be created for one or more additional processes or coprocessors. For example, a second memory PD may be created to execute a second process of the first processor in the second processor, or alternatively, in a third processor. Each process handed off by the main processor to a coprocessor, for example, can include a separate memory PD, or one or more processes executing within the same coprocessor may also share a common memory PD. The above and various other modifications within the scope of this disclosure will be apparent to one skilled in the art based on the description of the aspects herein.

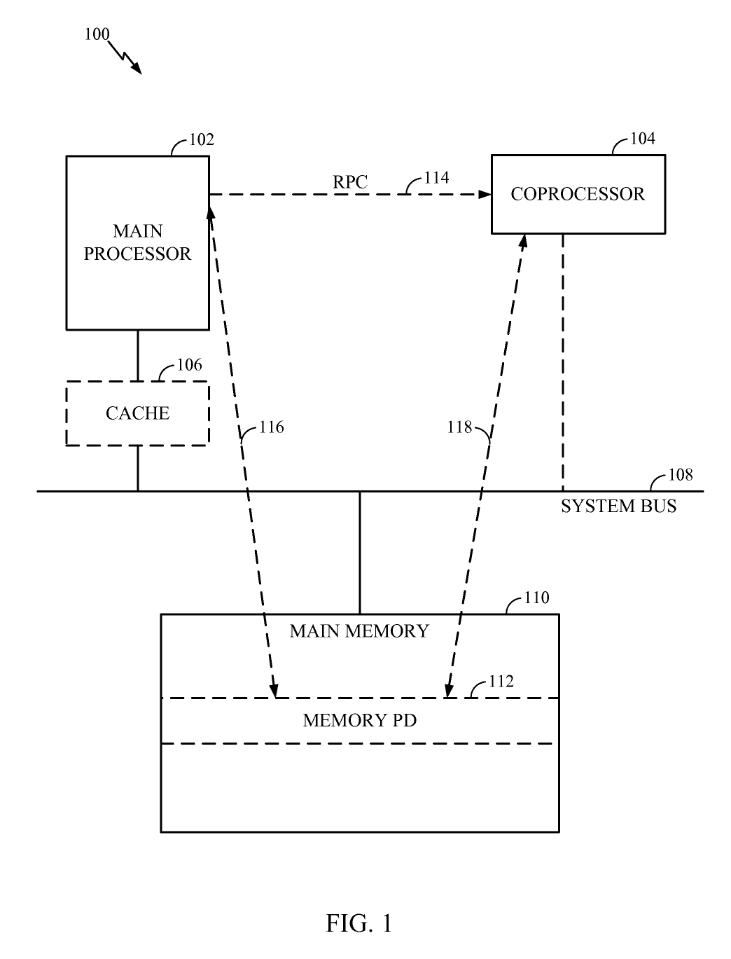

With reference now to FIG. 1, an exemplary aspect is illustrated with reference to a simplified schematic view of multiprocessing system 100. A first processor is shown as main processor 102, and a second processor is shown as coprocessor 104. Main processor 102 may have one or more levels of local and shared caches, collectively shown as cache 106. Coprocessor 104 may also have one or more local and shared caches (not shown). Main processor 102 and coprocessor 104 may have access to a common memory shown as main memory 110. It will be appreciated that in some aspects (not explicitly illustrated), the common memory may also be a shared cache such as a level 2 (L2) or level 3 (L3) cache. Main processor 102 and coprocessor 104 may have access to main memory 110 through system bus 108.

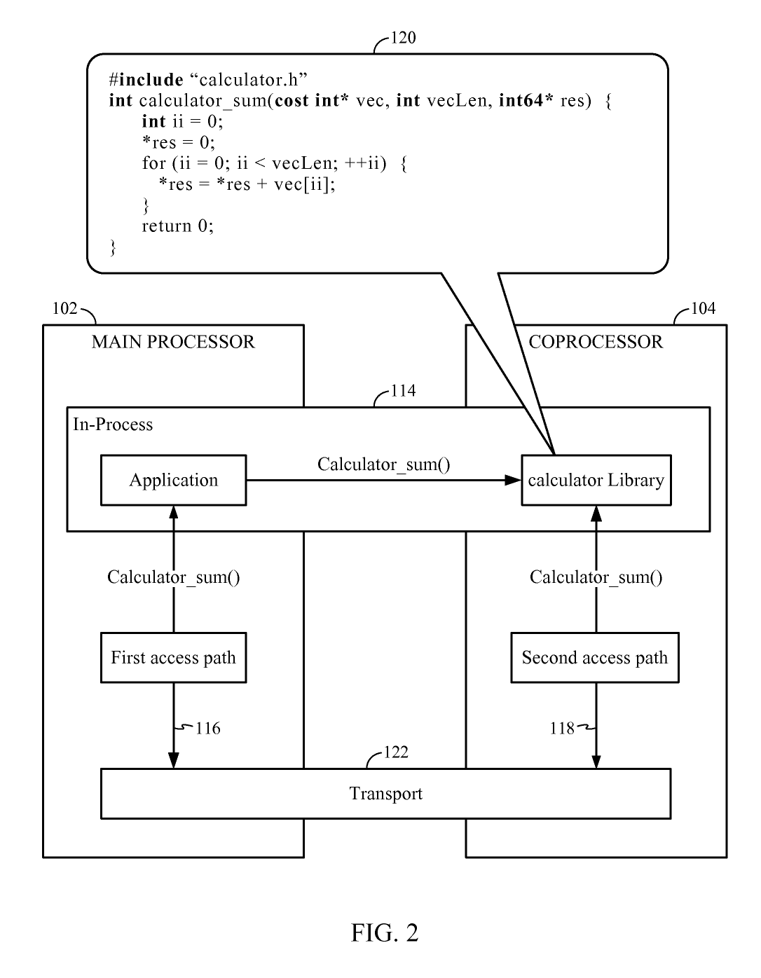

According to an exemplary aspect, main processor 102 may be configured to make a remote procedure call (RPC) 114 to coprocessor 104 for execution of a first process (not shown). First memory PD 112 may be created in main memory 110 related to the first process to coprocessor 104. In one example, a transport layer can be implemented to manage accesses to first memory PD 112 by main processor 102 and coprocessor 104. In the illustrated example, the transport layer can manage first access path 116 and second access path 118. First access path 116 may include, for example, a first kernel configured to operate on the HLOS and support system calls by main processor 102 and assist with translation of first virtual memory space of main processor 102 to physical memory space related to first memory PD 112 in main memory 110. Similarly, second access path 118 may operate on the operating system related to coprocessor 104 and assist with translation of the physical memory space related to first memory PD 112 to second virtual memory space of coprocessor 104. These aspects will be further explained with reference to FIG. 2, which depicts an example of the first process.

With combined reference to FIGS. 1-2, multiprocessing system 100 is illustrated in FIG. 2, for an example operation where the first process is a library function. In the illustrated example, the library function is “calculator_sum” identified by the reference numeral 120. According to an example, main processor 102 may be a general purpose or applications processor, configured to operate on a HLOS. Coprocessor 104 may be an audio DSP, operating under a reduced instruction set computing (RISC) architecture. Main processor 102 may encounter library function 120 and decide to handoff processing of library function 120 to coprocessor 104, in order to utilize the resources of coprocessor 104 and reduce the workload on main processor 102. The handoff may be performed by creating and extending a the first memory PD between main processor 102 and coprocessor 104, as explained with reference to FIG. 1, via the transport layer 122. Transport layer 122 may also encompass a streaming channel for forwarding information related to the RPC for library function 120 from main processor 102 to coprocessor 104.

In further detail, main processor 102 may make the system call to a first kernel (not shown), through first access path 116, for example, which may initiate creation of first memory PD 112. First access path 116 may also generally include mapping the context of main processor 102 in the HLOS to main memory 110, memory allocation in the main memory 110 for creation of first memory PD 112, and translation from first virtual memory space utilized by the HLOS on main processor 102 to physical memory space of main memory 110. Transport layer 122 may include creating of a sandboxed process for forming first memory PD 112 in main memory 110. Transport layer 122 may also assist in forwarding information or code related to library function 120 to coprocessor 104 and map arguments from main memory 110, synchronize any shared caches, and point relevant threads pertaining to library function 120 in main processor 102 to coprocessor 104. Second access path 118 may include a second kernel (not shown), configured to map arguments of coprocessor 104 from first memory PD 112 in main memory 110, and perform any related translation of physical memory space of main memory 110 to second virtual memory space of coprocessor 104.

In some aspects, upon completion of the first process or library function 120, coprocessor 104 may update main memory 110 in memory PD 112 with the results, for example through second access path 118. Main processor 102 may retrieve the results from memory PD 112 through first access path 116. In this manner, main processor 102 and coprocessor 104 can efficiently cooperate with high degree of security.

In some aspects the main processor 102 and coprocessor 104 may be part of a same system-on-a-chip or package, and system bus 108 may be a local bus configured to communicatively couple main processor 102 and coprocessor 104 to main memory 110 and first memory PD 112 within main memory 110.

Aspects of this disclosure may also be extended to cases where coprocessor 104 may be a remote processor, located off-chip from main processor 102 and main memory 110, and configured to connect to main memory 110 through a remote network, such as, a local area network (LAN), wide area network (WAN), wireless WAN (WAN), Ethernet, Internet, etc. In these cases, a virtual copy of first memory PD 112 may be created, wherein reads and writes to the virtual copy may be synchronized to reads and writes of first memory PD 112 located in main memory 110. Coprocessor 104 may be configured to execute the first process (e.g., library function 120) using the virtual copy. Accordingly, speed of cooperation between main processor 102 and remote coprocessor 104 may be improved.

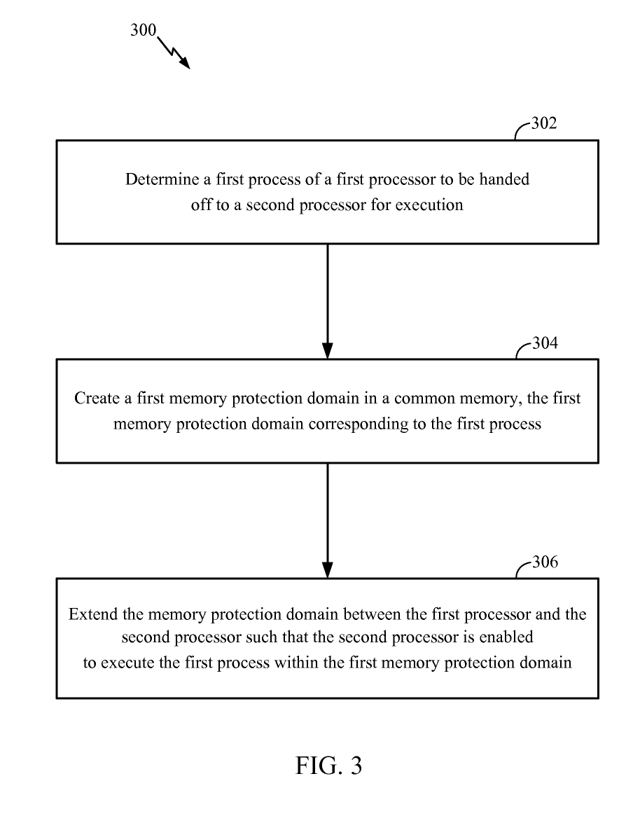

It will be appreciated that aspects include various methods for performing the processes, functions and/or algorithms disclosed herein. For example, as illustrated in FIG. 3, an aspect can include a method 300 of operating a multiprocessing system (e.g., multiprocessing system 100), the method comprising: determining a first process (e.g., library function 120) of a first processor (e.g., main processor 102) to be handed off to a second processor (e.g., coprocessor 104) for execution—Block 302. Method 300 can further comprise creating a first memory protection domain (PD) (e.g., first memory PD 112) in a common memory (e.g., main memory 110), the first memory PD corresponding to the first process—Block 304; and extending the first memory PD between the first processor and the second processor such that the second processor is enabled to execute the first process within the first memory PD—Block 306.

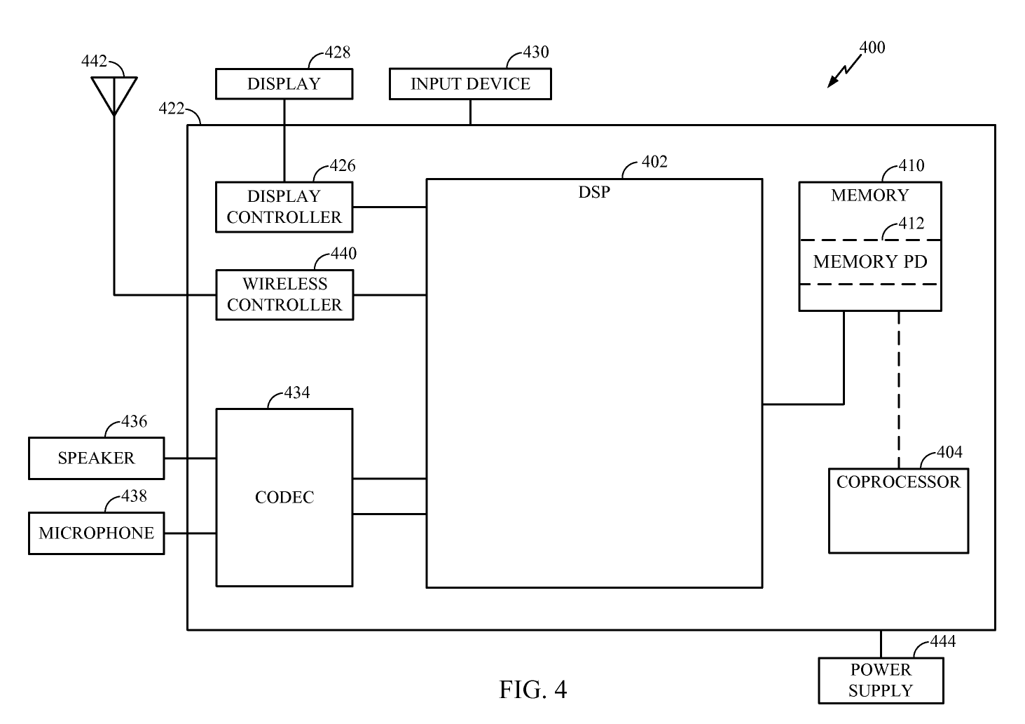

Referring now to FIG. 4, a block diagram of a wireless device that is configured according to exemplary aspects is depicted and generally designated 400. Wireless device 400 includes digital signal processor (DSP) 402, which may be configured similar to main processor 102 described according to exemplary aspects above. DSP 402 may be communicatively to memory 410, which may be similar to main memory 110, and may include memory PD 412, similar to first memory PD 112. Wireless device 400 may also include coprocessor 404 which may be communicatively coupled to memory 410, and configured to execute a first process of DSP 402, for example, by means of memory PD 412.

FIG. 4 also shows display controller 426 that is coupled to DSP 402 and to display 428. Coder/decoder (CODEC) 434 (e.g., an audio and/or voice CODEC) can be coupled to DSP 402. Other components, such as wireless controller 440 (which may include a modem) are also illustrated. Speaker 436 and microphone 438 can be coupled to CODEC 434. FIG. 4 also indicates that wireless controller 440 can be coupled to wireless antenna 442. In a particular aspect, DSP 402, display controller 426, memory 410, CODEC 434, and wireless controller 440 are included in a system-in-package or system-on-chip device 422.

In a particular aspect, input device 430 and power supply 444 are coupled to the system-on-chip device 422. Moreover, in a particular aspect, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts a wireless communications device, DSP 402 and memory 410 may also be integrated into a set-top box, a music player, a video player, an entertainment unit, a navigation device, a personal digital assistant (PDA), a fixed location data unit, a computer or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the exemplary aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for extending a memory protection domain from a main processor to a coprocessor. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of operating a multiprocessing system, the method comprising:
determining a first process of a first processor to be handed off to a second processor for execution;
creating a first memory protection domain in a common memory, the first memory protection domain corresponding to the first process; and
extending the memory protection domain between the first processor and the second processor such that the second processor is enabled to execute the first process within the first memory protection domain.

2. The method of claim 1, comprising limiting access of the common memory, by the first processor and the second processor, to the first memory protection domain, with regard to the first process.

3. The method of claim 1, comprising creating a first access path between the first processor and the first memory protection domain, wherein the first access path comprises translation of first virtual memory of the first processor to physical memory related to the first memory protection domain in the common memory.

4. The method of claim 3, wherein creating the first access path further comprises mapping context and arguments of the first processor to the first memory protection domain.

5. The method of claim 1, comprising creating a second access path between the first memory protection domain and the second processor, the second access path comprising translation of physical memory related to the first memory protection domain in the common memory to second virtual memory of the second processor.

6. The method of claim 5, wherein creating the second access path further comprises mapping context and arguments of the first memory protection domain to the second processor.

7. The method of claim 1, wherein the first processor and the second processor are heterogeneous.

8. The method of claim 1, wherein the first processor is a main processor and the second processor is a coprocessor.

9. A multiprocessing system comprising:
a common memory;
a first processor configured to handoff a first process to a second processor for execution; and
a first memory protection domain in the common memory, the first memory protection domain corresponding to the first process and configured to be extended between the first processor and the second processor such that the second processor is enabled to execute the first process within the first memory protection domain.

10. The multiprocessing system of claim 9, wherein access to the common memory, by the first processor and the second processor, is limited to the first memory protection domain, with regard to the first process.

11. The multiprocessing system of claim 9, comprising a first access path between the first processor and the first memory protection domain, wherein the first access path comprises translation of first virtual memory of the first processor to physical memory related to the first memory protection domain in the common memory.

12. The multiprocessing system of claim 11, wherein the first access path further comprises mappings of context and arguments of the first processor to the first memory protection domain.

13. The multiprocessing system of claim 9, comprising a second access path between the first memory protection domain and the second processor, the second access path comprising translation of physical memory related to the first memory protection domain in the common memory to second virtual memory of the second processor.

14. The multiprocessing system of claim 13, wherein the second access path further comprises mappings of context and arguments of the first memory protection domain to the second processor.

15. The multiprocessing system of claim 9, wherein the first processor and the second processor are heterogeneous.

16. The multiprocessing system of claim 9, wherein the first processor is a main processor and the second processor is a coprocessor.

17. A multiprocessing system comprising:
a common means for storing; and
a first means for processing configured to handoff a first process for execution to a second means for processing;
the common means for storing comprising a first memory protection domain, the first memory protection domain corresponding to the first process and configured to be extended between the first means for processing and the second means for processing such that the second means for processing is enabled to execute the first process within the first memory protection domain.

18. A non-transitory computer-readable storage medium comprising code, which, when executed by a processor, causes the processor to perform operations for operating a multiprocessing system, the non-transitory computer-readable storage medium comprising:
code for determining a first process of a first processor to be handed off to a second processor for execution;
code for creating a first memory protection domain (PD) in a common memory, the first memory PD corresponding to the first process; and
code for extending the memory PD between the first processor and the second processor such that the second processor is enabled to execute the first process within the first memory PD.
